(19) United States
(12) Patent Application Publication
(10) Pub. No.: US 2016/0121364 A1
(43) Pub. Date: May 5, 2016

(54) BAKING METHOD AND DEVICE FOR METALLIC PASTE ON TRANSPARENT SUBSTRATE

(71) Applicant: NANOBIT TECH. CO., LTD., Taoyuan County (TW)

(72) Inventors: Shiou-Ming LIU, Taoyuan County (TW); Yu-Yang CHANG, Taoyuan County (TW); Shuei-Chuan WANG, Taoyuan County (TW)

(21) Appl. No.: 14/591,134

(22) Filed: Jan. 7, 2015

(30) Foreign Application Priority Data
Oct. 30, 2014 (TW) 103137696

(51) Int. Cl. B05D 3/02; B05B 15/00; B05D 3/06

(52) U.S. Cl. CPC B05D 3/0263; B05D 3/06; B05B 15/00

(57) ABSTRACT

A baking method for metallic paste on transparent substrate first prepares a thin transparent substrate coated with metallic paste and the thin transparent substrate is arranged in roll-to-roll or in batch to a baking area of a baking device. A near-infrared light source with a predetermined distance with the baking area is provided, and the near-infrared light source irradiates a near-infrared light with predetermined wavelength to the thin transparent substrate for baking process. In baking operation, the thin transparent substrate is placed on the baking area for static baking or dynamic baking. The thin transparent substrate is then sent to a cooling stabilization area for normal cooling.

### BACKGROUND OF THE INVENTION

1. Field of the Invention

The present invention relates to a baking device, especially to a baking device for baking transparent substrate coated with metallic paste layer and method for the same.

2. Description of the Prior Art

As the progress of electronic products, the substrate is generally coated with or additional with other material on surface thereof. For example, flexible film or glass substrate is generally coated with conductive material for manufacturing conductive layer. Moreover, conductive layer or insulating layer of other kinds of materials can also be additional on the substrate.

Taking portable communication device (such as mobile phone or navigation system) as example, transparent touch panel is generally provided on the front face of the display device. The touch panel comprises substrate and internal elements such as transparent conductive layer, black photoresist or touch signal traces. The substrate is used to mount and protect those internal elements. The substrate has sensing area and peripheral around the sensing area. The transparent conductive layer is first arranged on the sensing area and the peripheral area and then a black photoresist is covered on the transparent conductive layer on the peripheral area.

The above-mentioned material pasting and processing procedures are complicated and involve lots kinds of materials. For example, if transparent conductive material is formed on the surface of the substrate and then another conductive material is to be formed on the transparent conductive material, the following process should not damage the already-formed transparent conductive material or substrate. However, the softening temperature of the plastic substrate is only 120° C. and the baking temperature of silver paste is 130° C. The baking of silver paste will deform the plastic substrate if the silver paste is coated on the plastic substrate for manufacturing circuit traces. It is desirable to provide a baking device or baking method for a particular paste, while the baking operation will not have impact on the material adjacent to the particular paste, the manufacturing process can be simplified.

Moreover, the prior art baking process generally involves oven or heater exerts considerable heat to the coated paste to dry the paste. The control of the heat source is complicated and lots of energy is waste.

Different to the conventional oven heating way, microwave heating can heat particular material such as metal or water with particular wavelength to heat the particular material in short time. Moreover, Taiwan Patent Gazette No. 476845 also discloses a far-infrared heating technology to dry resin paste on acrylic substrate with temperature below 100° C. and with time of several minutes. The far-infrared radiation can penetrate into inner part of the paste and can achieve fast heating.

It is desirable to use the particular wavelength range of thermal source to fast heating the metallic paste layer. It is also desirable to heat particular paste such as pasted transparent conductive film on surface of touch panel, thus saving energy.

### SUMMARY OF THE INVENTION

It is an object of the present invention to provide a baking device and method for baking transparent substrate coated with metallic paste layer with baking effect of uniform temperature, low temperature and short time. The baking device and method also has low thermal impact (it means the additional temperature increase due to thermal radiation by the near-infrared light) to the thin transparent substrate.

Accordingly, the present invention provides a baking method for metallic paste on transparent substrate, the method comprising: preparing a thin transparent substrate coated with metallic paste; arranging the thin transparent substrate in roll-to-roll or in batch to a baking area of a baking device; providing a near-infrared light source with a predetermined distance with the baking area, and the near-infrared light source irradiating a near-infrared light with predetermined wavelength to the thin transparent substrate for baking process; placing the thin transparent substrate on the baking area for static baking or dynamic baking; and sending the thin transparent substrate to a cooling stabilization area for normal cooling.

According to an embodiment of the present invention, the surface of the thin transparent substrate has hardened treatment, and the thin transparent substrate is PET substrate.

According to an embodiment of the present invention, an electric-conductive ink having 20-100 nm thickness and containing carbon nanotube (CNT) is coated on the surface of the thin transparent substrate to form a transparent conductive film.

According to an embodiment of the present invention, a silver paste with thickness of 8±3 um is printed on the thin transparent substrate.

According to an embodiment of the present invention, the baking device further comprises a supporter with an inlet and an outlet, and a near-infrared light source on one side of the supporter and corresponding to the baking area.

According to an embodiment of the present invention, the supporter is made of stainless steel.

According to an embodiment of the present invention, the supporter is a baking stage having a lifting positioning unit, the lifting positioning unit having a baffle driven by a lifter in the baking stage.

According to an embodiment of the present invention, the baking area is a roller set to provide dynamic baking, the roller is made of stainless steel and has conveying belt made of teflon glass fabrics.

According to an embodiment of the present invention, the baking area is a roller set to provide dynamic baking, the roller is made of stainless steel and has conveying belt made of teflon glass fabrics.

According to an embodiment of the present invention, the near-infrared light source comprises a plurality of near-infrared generators to generate a near-infrared light with wavelength of 800-2000 nm, peak wavelength of 1000 nm and power of 2.78˜8.46 W.

According to an embodiment of the present invention, the near-infrared light source has power more than 4 W.

According to an embodiment of the present invention, the near-infrared light source provides a unit radiation energy of 2.78˜8.46 W to dry the thin transparent substrate having 1 square meter unit area and coated with the metallic paste layer.

According to an embodiment of the present invention, the baking area is separated with the near-infrared light source by a distance of 15˜50 cm.

According to an embodiment of the present invention, the baking area is separated with the near-infrared light source by a distance of 25˜30 cm.

According to an embodiment of the present invention, the static baking operation is conducted under the conditions of 25/100˜30/150 cm/second, where length unit cm is used to count a vertical distance between the near-infrared light source and the thin transparent substrate, and time unit second is used to count the baking time.

According to an embodiment of the present invention, the dynamic baking operation is conducted under the conditions of 25/70˜30/100 cm/second, where length unit cm is used to count a vertical distance between the near-infrared light source and the thin transparent substrate, and time unit second is used to count the baking time.

According to an embodiment of the present invention, it provides a feeder mechanism and a discharging mechanism arranged at front end and rear end of the baking device, respectively, a rear end of the feeder mechanism is coupled to the cooling stabilization region.

According to an embodiment of the present invention, it further provides an air exhauster arranged on one side of the baking device.

According to an embodiment of the present invention, it further provides a supporting tray, the supporting tray is made of plastic substrate or glass substrate.

Accordingly, the present invention provides a baking device for baking metallic paste on transparent substrate, the baking device comprising: a supporter having an inlet and an outlet; a near-infrared light source arranged on one side of the supporter and providing infrared light with a predetermined wavelength; a baking area arranged on one side of the supporter and corresponding to the near-infrared light source, the baking area having a predetermined distance with the near-infrared light source, wherein thin transparent substrates are fixed in roll-to-roll or in batch to the baking area of the baking device, and the near-infrared light source irradiates infrared light with the predetermined wavelength to the thin transparent substrates.

According to an embodiment of the present invention, the supporter comprises a plurality of plates and pillars, and is made of stainless steel.

According to an embodiment of the present invention, the near-infrared light source comprises a plurality of near-infrared generators to generate a near-infrared light with wavelength of 800-2000 nm, peak wavelength of 1000 nm and power of 2.78˜8.46 W.

According to an embodiment of the present invention, the near-infrared light source has power more than 4 W.

According to an embodiment of the present invention, the backing device has a baking stage made of stainless steel and corresponding to the near-infrared light source, the baking stage is separated with the near-infrared light source by 15-50 cm.

According to an embodiment of the present invention, the backing device has a baking stage made of stainless steel and corresponding to the near-infrared light source, the baking stage is separated with the near-infrared light source by 25-30 cm.

According to an embodiment of the present invention, the baking stage is covered with a non-heat accumulating unit made of teflon glass fabrics.

According to an embodiment of the present invention, the baking stage has a lifting positioning unit, the lifting positioning unit has a baffle driven by a level-lifter in the baking stage, the level-lifter is pneumatic cylinder or hydraulic cylinder.

According to an embodiment of the present invention, a static baking operation is conducted under the conditions of 25/100˜30/150 cm/second, where length unit cm is used to count a vertical distance between the near-infrared light source and the thin transparent substrate, and time unit second is used to count the baking time.

According to an embodiment of the present invention, the baking area is a roller set to provide dynamic baking, the roller is made of stainless steel and has conveying belt made of teflon glass fabrics.

According to an embodiment of the present invention, a dynamic baking operation is conducted under the conditions of 25/70˜30/100 cm/second, where length unit cm is used to count a vertical distance between the near-infrared light source and the thin transparent substrate, and time unit second is used to count the baking time.

According to an embodiment of the present invention, a feeder mechanism and a discharging mechanism are arranged at front end and rear end of the baking device, respectively, a rear end of the feeder mechanism is coupled to a cooling stabilization region.

According to an embodiment of the present invention, it further comprises an air exhauster arranged on one side of the supporter.

According to an embodiment of the present invention, it further comprises a supporting tray, the supporting tray is made of plastic substrate or glass substrate.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows the flowchart of baking metallic paste layer on a transparent substrate.

FIG. 2 shows the schematic view of the baking device of the present invention.

FIG. 3 is section view of FIG. 2.

FIG. 4 shows the schematic view of the baking device for baking metal paste layer on transparent substrate according to another embodiment of the present invention.

FIG. 5 is a section view showing the conveying operation in FIG. 4.

FIG. 6 shows the section view of the baking device for baking metallic paste layer on transparent substrate according to still another embodiment of the present invention.

### DETAILED DESCRIPTION OF THE INVENTION

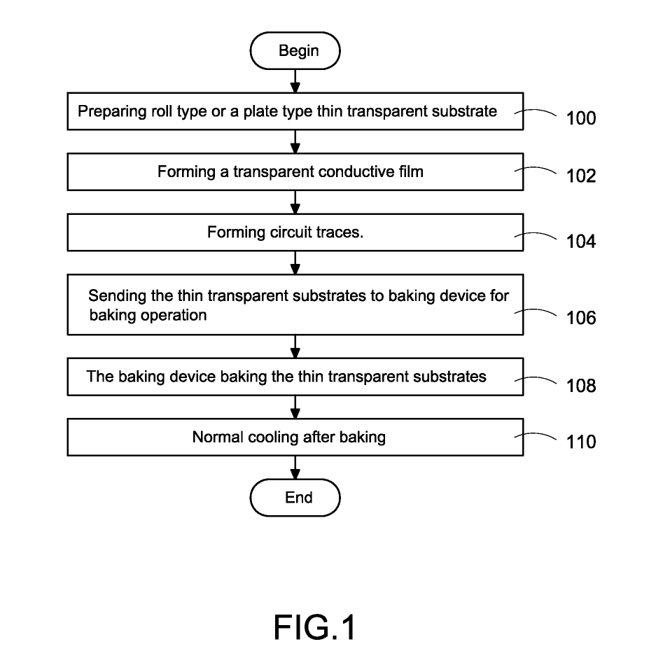

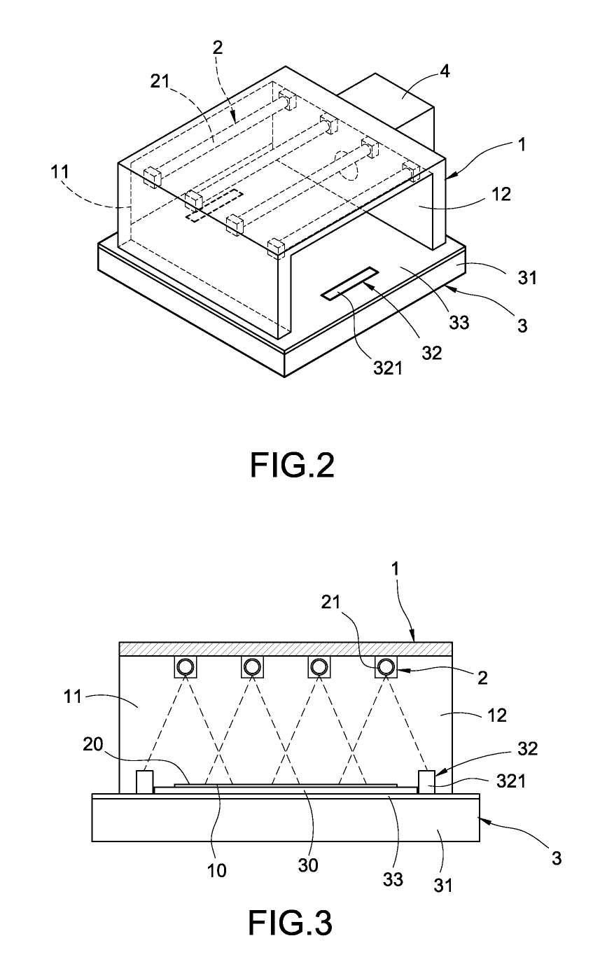

FIG. 1 shows the flowchart of baking metallic paste layer on a transparent substrate. With reference also to FIGS. 2 and 3, first in step 100, a roll type or a plate type thin transparent substrate 10 and a surface hardening process is conducted on the transparent substrate 10. In the shown embodiment, the thin transparent substrate 10 is a Polyethylene Terephthalate (PET) substrate.

In step 102, electric-conductive ink of 20-100 nm thickness and containing carbon nanotube (CNT) is coated on the surface of the thin transparent substrate 10 to form a transparent conductive film.

In step 104: silver paste is printed on the thin transparent substrate 10 to form circuit traces. The transparent conductive film circuit traces constitute a metal paste layer 20.

In step 106, after pasting the metallic paste layer 20 on the thin transparent substrate 10 (roll type or plate type), the thin transparent substrates 10 are placed on a supporting tray (not shown) in roll-to-roll manner or batch manner, and the thin transparent substrates 10 are sent to the baking area 3 of the a baking device for baking operation. In these drawings, the baking area 3 is a baking stage 31 with a lifting positioning unit 32. The material of the baking stage 31 is stainless steel or stainless steel covered with non-heat accumulating unit 33 (such as teflon glass fabrics) such that the baking stage 31 has poor absorption for the infrared source 2 and will not accumulate heat. Alternatively, the baking area 3 is a roller set 34 to providing dynamic baking. The roller set 34 is made of stainless steel and used with conveying belt 35 made of teflon glass fabrics to reduce accumulated heat.

In step 108, the near-infrared source 2 generates a near-infrared radiation of 800˜2000 nm wavelength, wherein the main energy is from the 1000 nm region and the energy provided is 2.78˜8.46 W, preferably more than 4 W. The baking area is separated with the near-infrared source 2 with a distance of 15-50 cm, and preferably 25-30 cm. The unit radiation energy of 2.78˜8.46 W can dry the thin transparent substrate having 1 square meter unit area and coated with the metallic paste layer 20. The static baking operation is preferably conducted under the conditions of 25/100˜30/150 cm/second, where the length unit (cm) is used to count the vertical distance between the near-infrared light source 2 and the thin transparent substrate, and the time unit (second) is used to count the baking time. The dynamic baking operation is preferably conducted under the conditions of 25/70˜30/100 cm/second, where the length unit (cm) is used to count the vertical distance between the near-infrared light source 2 and the thin transparent substrate, and the time unit (second) is used to count the baking time.

In step 110, normal cooling (stabilization) is conducted for five minutes after baking.

FIG. 2 shows the schematic view of the baking device of the present invention, which comprises a supporter 1, a near-infrared light source 2, a baking area 3 and an air exhauster 4.

The supporter 1 is constituted with a plurality of plates or pillars and has an inlet 11 and an outlet 12. In the shown embodiment, the supporter 1 is made of stainless steel, which has fast heat dissipation under room temperature and will not accumulate heat.

The near-infrared light source 2 is constituted with a plurality of near-infrared light generators 21 arranged on one lateral face of the supporter 1. The near-infrared light generators 21 generate near-infrared radiation of 800˜2000 nm wavelength, wherein the main energy is from the 1000 nm region and the power provided is 2.78˜8.46 W, preferably more than 4 W. In the shown embodiment, the near-infrared light generator 21 is near-infrared lamp.

The baking area 3 comprises a baking stage 31 made of stainless steel and is arranged on a lateral face of the supporter 1. The baking stage 31 is arranged corresponding to the near-infrared light source 2 and is separated with the near-infrared light source 2 by a distance of 15˜50 cm, preferably 25˜30 cm. The baking stage 31 has a lifting positioning unit 32 with a baffler 321 driven by a level-lifter 322 in the baking stage 31. The baffler 321 is hidden in the baking stage 31 as the baffler 321 is not moved up. After the thin transparent substrate (not shown) coated with the metallic paste layer (not shown) enters the supporter 1, the level-lifter in the baking stage 31 is lifted with the control of the external controller and projects from the surface of the baking stage 31 to cover the thin transparent substrate. After baking, the baffler 321 is driven by the level-lifter to retreat into the inner space of the baking stage 31. Moreover, a non-heat-accumulating unit 33 made of teflon glass fabrics covers the surface of the baking stage 31. The non-heat-accumulating unit 33 has poor heat absorption for the near-infrared light source 2, thus not accumulating heat. In the shown embodiment, the level-lifter 322 is pneumatic cylinder or hydraulic cylinder.

The air exhauster 4 is arranged on one side of the supporter 1 to remove the volatile solvent after the metallic paste layer is dried or control the surface temperature of the panel (the thin transparent substrate of supporting tray). In the shown embodiment, the air exhauster 4 is an exhaust fan.

FIG. 2 is a schematic view showing the operation of the baking device for baking metallic paste layer on transparent substrate, and FIG. 3 is a section view of FIG. 2. As shown in these figures, for plate type transparent substrate 10, the thin transparent substrate 10 coated with the metallic paste layer 20 is placed on the supporting tray 30. The supporting tray 30 conveys the thin transparent substrate 10 to the surface of the baking stage 31 within the supporter 1. The level-lifter (not shown) in the baking stage 31 is lifted with the control of an external controller and projects from the surface of the baking stage 31 to cover the thin transparent substrate. For static baking operation, the static baking operation is preferably conducted under the conditions of 25/100˜30/150 cm/second, where the length unit (cm) is used to count the vertical distance between the infrared source 2 and the thin transparent substrate, and the time unit (second) is used to count the baking time. In the baking operation, the air exhauster 4 is also activated to remove the volatile solvent during baking of the metal paste layer 20 or control the surface temperature. After baking, the baffler 321 is driven by the level-lifter to retreat into the inner space of the baking stage 31. Afterward, the supporting tray 30 can be removed, where the supporting tray 30 is plastic substrate or glass substrate.

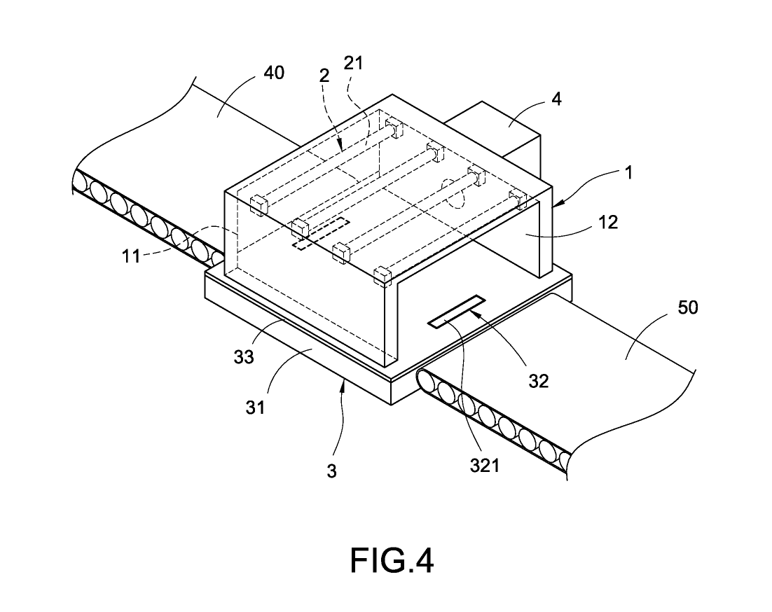

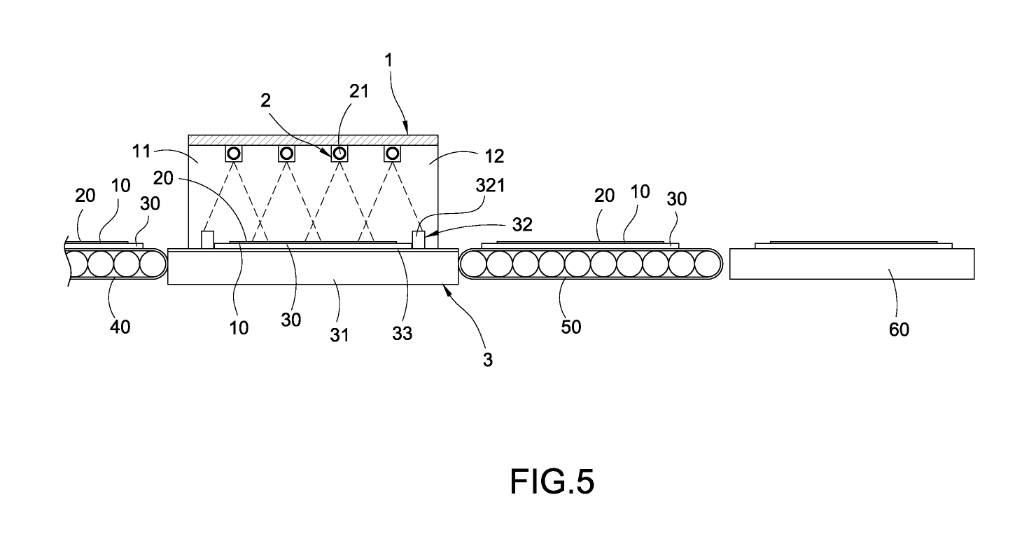

FIG. 4 shows the schematic view of the baking device for baking metal paste layer on transparent substrate according to another embodiment of the present invention. FIG. 5 is a section view showing the conveying operation in FIG. 4. As shown in the figures, for plate type transparent substrate 10, a feeder mechanism 40 and a discharging mechanism 50 are arranged at front end and rear end of the baking device, respectively. The feeder mechanism 40 and the discharging mechanism 50 can be conveying belt, robot arm or pneumatic cylinder. In this figure, the feeder mechanism 40 and the discharging mechanism 50 are exemplified with conveying belt constituted by a plurality of rollers and belt.

For the baking operation of the plate type transparent substrate 10, the thin transparent substrate 10 coated with the metallic paste layer 20 is placed on the supporting tray 30 and the supporting tray 30 is placed into the feeder mechanism 40. The feeder mechanism 40 sends the supporting tray 30 into the original location of the baking stage 31 in the supporter 1 for baking operation. After baking operation, the supporting tray 30 carrying the dried thin transparent substrate 10 is moved to the discharging mechanism 50 by pneumatic cylinder (not shown) or robot arm (not shown) in the supporter 1. The discharging mechanism 50 then discharges the supporting tray 30 carrying the dried thin transparent substrate 10.

Moreover, a cooling stabilization area 60 is arranged on the discharging mechanism 50, thus reducing the temperature of the thin transparent substrate 10.

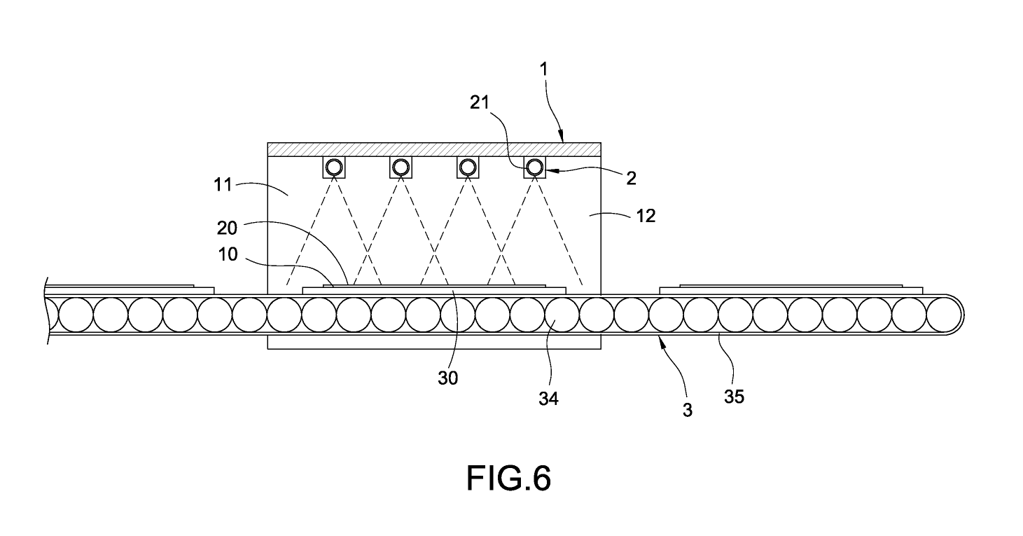

FIG. 6 shows the section view of the baking device for baking metallic paste layer on transparent substrate according to still another embodiment of the present invention. The embodiment shown in FIG. 6 is similar to that in FIG. 2 except that the baking area comprises roller set 34 to provide dynamic baking operation. The roller set 34 is made of stainless steel and used with conveying belt 35 made of teflon glass fabrics to reduce accumulated heat.

After pasting the metallic paste layer 20 on the thin transparent substrate 10 (roll type or plate type), the thin transparent substrate 10 is placed on a supporting tray 30 in roll-to-roll manner or batch manner. The supporting tray 30 is then placed on the conveying belt 35 to send the supporting tray 30 into the supporter 1. A dynamic baking operation is conducted and preferably conducted under the conditions of 25/70˜30/100 cm/second, where the length unit (cm) is used to count the vertical distance between the near-infrared light source 2 and the thin transparent substrate, and the time unit (second) is used to count the baking time. After baking, the thin transparent substrate 10 is sent to the cooling stabilization area 60 for normal cooling (stabilization) with five minutes.

The object and advantages of the method and device for baking metallic paste layer on a transparent substrate can be better understood by following embodiments and comparative examples.

Embodiment 1 (the first structure) of the present invention uses three near-infrared light source (hereinafter the near-infrared light source is referred to light source for brevity) in parallel arrangement. The light source has length of 60 cm and separation of 20 cm between two adjacent light sources. The power of light is 4.61 W and the light wavelength is 800 nm-2000 nm. The distance between the light source and the thin transparent substrate 10 (such as PET file) coated with silver paste to be dried is 30 cm. The thin transparent substrate 10 is moved to the baking area with speed of 1 m/min and is then moved out of the baking area to keep rest for five minutes until the surface temperature of the thin transparent substrate 10 is back to room temperature (The experiment is to emphasize that the baking process can be applied to dynamic R2R operation).

Embodiment 2 (the second structure) of the present invention uses two near-infrared light sources in parallel arrangement. The light source has length of 60 cm and separation of 20 cm between two adjacent light sources. The power of light is 4.61 W and the light wavelength is 800 nm-2000 nm. The distance between the light source and the thin transparent substrate 10 (such as PET file) coated with silver paste to be dried is 30 cm. The thin transparent substrate 10 is dried at static state for 150 seconds and then keeps rest in room temperature for five minutes until the he surface temperature of the thin transparent substrate 10 is back to room temperature (The experiment is to emphasize that the baking process can be applied to static normal operation).

Embodiment 3 (the second structure) of the present invention uses two near-infrared light sources in parallel arrangement. The light source has length of 60 cm and separation of 15 cm between two adjacent light sources. The power of light is 4.61 W and the light wavelength is 800 nm-2000 nm. The distance between the light source and the thin transparent substrate 10 (such as PET file) coated with silver paste to be dried is 30 cm. The thin transparent substrate 10 is dried at static state for 120 seconds and then keeps rest in room temperature for five minutes until the surface temperature of the thin transparent substrate 10 is back to room temperature (The experiment is to emphasize that the baking process can be applied to another static normal operation).

Embodiment 4 for the present invention is similar to the embodiment 3 except that the thin transparent substrate 10 is replaced with thin transparent conductive film with transparent conductive material formed on surface thereof. The transparent conductive film is coated with silver paste and then sent to baking area for static baking of 150 seconds. The dried transparent conductive film is kept rest in room temperature for five minutes until the surface temperature of the thin transparent substrate 10 is back to room temperature (The experiment is to emphasize that the baking process can be applied to the thin transparent conductive film coated with silver paste).

Embodiment 5 for the present invention is similar to the structure 2 except that distance between the light source and the thin transparent substrate 10 (such as PET file) coated with silver paste to be dried is 25 cm. The thin transparent substrate 10 is dried at static state for 100 seconds and then keeps rest in room temperature for five minutes until the surface temperature of the thin transparent substrate 10 is back to room temperature (The experiment is to emphasize that the baking process can be applied to light source with different height).

Embodiment 5 for the present invention is similar to the structure 2 except that an air exhauster is additionally provided. The thin transparent substrate 10 (such as PET file) is coated with silver paste and then sent to the baking area. The thin transparent substrate 10 is dried at static state for 150 seconds and then keeps rest in room temperature for five minutes until the surface temperature of the thin transparent substrate 10 is back to room temperature (The experiment is to emphasize that the baking process can be applied to baking operation equipped with air exhauster).

Comparative example 1 uses electric oven for baking. The electric oven provides hot air circulation of 130° C. and then is dried at static state for 1800 seconds and then keeps rest in room temperature for 20 minutes until the surface temperature of the thin transparent substrate 10 is back to room temperature (The experiment is to emphasize a long baking process).

Comparative example 2 is similar to the embodiment 3 of the present invention (structure 2) except that the light source is replaced with far-infrared generator. The thin transparent substrate 10 is dried at static state for 240 seconds and then keeps rest in room temperature for 5 minutes until the surface temperature of the thin transparent substrate 10 is back to room temperature (The experiment is to emphasize the deformation of thin transparent substrate caused by baking operation).

Comparative example 2 is similar to the embodiment 3 of the present invention (structure 2) except that the light source is separated by 40 cm. The thin transparent substrate 10 is dried at static state for 120 seconds and then keeps rest in room temperature for 5 minutes until the surface temperature of the thin transparent substrate 10 is back to room temperature (The experiment is to emphasize that the baking operation only has baking effect to part of the thin transparent substrate under this baking condition).

Comparative example 4 is similar to the embodiment 3 of the present invention (structure 2) except that the power of the light source is 3.77 W. The thin transparent substrate 10 is dried at static state for 300 seconds and then keeps rest in room temperature for 5 minutes until the surface temperature of the thin transparent substrate 10 is back to room temperature (The experiment is to emphasize that the baking operation requires a minimal power to achieve baking effect).

The Detailed Specification

| Item | Specification | Note |
|---|---|---|
| Transparent | PET 125 um | Surface hardening treatment |
| substrate | | |
| Silver paste | Silver paste of Asahi 430B | Mesh-pasted with thickness |
| | | of 8 ± 3 um |
| Transparent | Conductive ink containing | Spraying the conductive ink |
| conductive | Carbon nanotube | on the PET surface to form |
| film | | conductive film of 20-100 nm |
| | | thickness |

The discrimination method for identifying the baking degree on the surface of the substrate after the conductive ink is dried. The adhesion test is conducted with Adhesion Cross-Cut Testers to cut 100 meshes (1 mm×1 mm per mesh). A 3M (600) adhesive tape is stuck on the cut portion and then torn away. The adhesion degree can be identified by observing whether the pasted article is peeled off. The substrate has intact cutting edge and no pasted film is peeled off.

Comparison table

| | Embodiment | | | | | | | | | | | | Comparative example | | | | | | |
|---|---|---|---|---|---|---|---|---|---|---|---|---|---|---|---|---|---|---|---|
| | 1 | | 2 | | 3 | | 4 | | 5 | | 6 | | 1 | 2 | | 3 | | 4 | |
| PET | Yes | | Yes | | Yes | | Yes | | Yes | | Yes | | Yes | Yes | | Yes | | Yes | |
| Transparent | No | | No | | No | | Yes | | No | | No | | No | No | | No | | No | |
| conductive | | | | | | | | | | | | | | | | | | | |
| film | | | | | | | | | | | | | | | | | | | |
| Silver paste | Yes | | Yes | | Yes | | Yes | | Yes | | Yes | | Yes | Yes | | Yes | | Yes | |
| Distance | 20 | cm | 20 | cm | 15 | cm | 20 | cm | 20 | cm | 20 | cm | | 20 | cm | 40 | cm | 20 | cm |
| between two | | | | | | | | | | | | | | | | | | | |
| light sources | | | | | | | | | | | | | | | | | | | |
| Distance | 30 | cm | 30 | cm | 30 | cm | 30 | cm | 25 | cm | 30 | cm | | 30 | cm | 30 | cm | 30 | cm |
| between | | | | | | | | | | | | | | | | | | | |
| light source | | | | | | | | | | | | | | | | | | | |
| and sample | | | | | | | | | | | | | | | | | | | |
| Oven | No | | No | | No | | No | | No | | No | | Yes | No | | No | | No | |
| heating | | | | | | | | | | | | | | | | | | | |
| Far-Infrared | No | | No | | No | | No | | No | | No | | No | Yes | | No | | No | |
| heating | | | | | | | | | | | | | | | | | | | |
| Baking time | 100 | | 150 | | 120 | | 150 | | 100 | | 150 | | 1800 | 240 | | 120 | | 300 | |
| (second) | | | | | | | | | | | | | | | | | | | |
| Surface | 95° | C. | 104° | C. | 109° | C. | 106° | C. | 110° | C. | 101° | C. | 130° C. | 135° | C. | 107° | C. | 90° | C. |
| temperature | | | | | | | | | | | | | | | | | | | |
| of silver | | | | | | | | | | | | | | | | | | | |
| paste | | | | | | | | | | | | | | | | | | | |
| Surface | 85° | C. | 94° | C. | 98° | C. | 116° | C. | 99° | C. | 93° | C. | 130° C. | 127° | C. | 98° | C. | 81° | C. |
| temperature | | | | | | | | | | | | | | | | | | | |
| of substrate | | | | | | | | | | | | | | | | | | | |

| Rest time | 5 | 5 | 5 | 5 | 5 | 5 | 30 | 5 | 5 | 5 |
|---|---|---|---|---|---|---|---|---|---|---|
| (Minute) | | | | | | | | | | |
| Baking | Intact cutting edge and no peeled off paste film | | | | | | | | Beads present on cut | |
| effect of | | | | | | | | | edge and cross point, | |
| silver paste | | | | | | | | | the peeled off region | |
| | | | | | | | | | is 5-15% of total region | |
| Substrate | OK | OK | OK | OK | OK | OK | NG | NG | OK | OK |
| deformation | | | | | | | | | | |
| evaluation | | | | | | | | | | |

From the result of the Embodiments 1-6 shown in the table, the baking device of the present invention can provide the baking operation for the thin transparent substrate 10 coated with silver paste. The surface temperature of the thin transparent substrate 10 can be controlled to be below 120° C. and the baking time can be within 150 seconds. On the contrary, the prior art oven baking and far-infrared baking (comparative examples 1 and 2) need higher temperature of 130° C. and baking time of 240 seconds. Moreover, the prior art processes also suffer deform problem of thin transparent substrate after baking. Moreover, the prior art processes also need to precisely control distance between two far-infrared generators and the distance between the far-infrared generator and the thin transparent substrate 10 to achieve optimal result. Otherwise, the imperfect baking or peeling off may occur when the distance between two far-infrared generators 21 is excessively larger (comparative example 3) or insufficient energy of far-infrared generators 21 (comparative example 4). Moreover, the baking device of the present invention can be applied to the baking operation of the silver paste pasted on the PET substrate.

Moreover, the baking device of the present invention can be applied to the thin transparent substrate 10 coated with transparent conductive film such as CNT transparent conductive film (Embodiment 4).

Furthermore, the present invention utilizes the heating effect of the near-infrared generators 21 to the metallic paste layer and can additionally set air exhauster 4 in the baking device. The solvent of the silver paste can be removed while the baking effect of the silver paste is not influenced.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A baking method for metallic paste on transparent substrate, comprising:
a) preparing a thin transparent substrate coated with metallic paste;
b) arranging the thin transparent substrate in roll-to-roll or in batch to a baking area of a baking device;
c) providing a near-infrared light source with a predetermined distance with the baking area, and the near-infrared light source irradiating a near-infrared light with predetermined wavelength to the thin transparent substrate for baking process;
d) in step c, placing the thin transparent substrate on the baking area for static baking or dynamic baking;
e) sending the thin transparent substrate to a cooling stabilization area for normal cooling.

2. The baking method in claim 1, further comprising: in step a, performing surface hardening treatment to the thin transparent substrate, the thin transparent substrate is polyethylene terephthalate (PET) substrate.

3. The baking method in claim 1, wherein an electric-conductive ink having 20-100 nm thickness and containing carbon nanotube (CNT) is coated on the surface of the thin transparent substrate to form a transparent conductive film.

4. The baking method in claim 1, wherein a silver paste with thickness of 8±3 um is printed on the thin transparent substrate.

5. The baking method in claim 1, wherein in step b the baking device further comprises a supporter with an inlet and an outlet, and a near-infrared light source on one side of the supporter and corresponding to the baking area.

6. The baking method in claim 5, wherein the supporter is made of stainless steel.

7. The baking method in claim 5, wherein the supporter is a baking stage having a lifting positioning unit, the lifting positioning unit having a baffle driven by a level-lifter in the baking stage.

8. The baking method in claim 7, wherein the baking stage material of the baking stage is made of stainless steel and covered with non-heat accumulating unit made of teflon glass fabrics.

9. The baking method in claim 5, wherein the baking area is a roller set to provide dynamic baking, the roller is made of stainless steel and has conveying belt made of teflon glass fabrics.

10. The baking method in claim 5, wherein in step c the near-infrared light source comprises a plurality of near-infrared generators to generate a near-infrared light with wavelength of 800-2000 nm, peak wavelength of 1000 nm and power of 2.78˜8.46 W.

11. The baking method in claim 10, wherein the near-infrared light source has power more than 4 W.

12. The baking method in claim 5, wherein the near-infrared light source provides a unit radiation energy of 2.78˜8.46 W to dry the thin transparent substrate having 1 square meter unit area and coated with the metallic paste layer.

13. The baking method in claim 5, wherein in step c, the baking area is separated with the near-infrared light source by a distance of 15˜50 cm.

14. The baking method in claim 13, wherein in step c, the baking area is separated with the near-infrared light source by a distance of 25˜30 cm.

15. The baking method in claim 5, wherein in step d, the static baking operation is conducted under the conditions of 25/100˜30/150 cm/second, where length unit cm is used to count a vertical distance between the near-infrared light source and the thin transparent substrate, and time unit second is used to count the baking time.

16. The baking method in claim 10, wherein in step d, the dynamic baking operation is conducted under the conditions of 25/70˜30/100 cm/second, where length unit cm is used to count a vertical distance between the near-infrared light source and the thin transparent substrate, and time unit second is used to count the baking time.

17. The baking method in claim 1, wherein step b further provides a feeder mechanism and a discharging mechanism arranged at front end and rear end of the baking device, respectively, a rear end of the feeder mechanism is coupled to the cooling stabilization region.

18. The baking method in claim 1, wherein step b further provides an air exhauster arranged on one side of the baking device.

19. The baking method in claim 1, wherein step b further provides a supporting tray, the supporting tray is made of plastic substrate or glass substrate.

20. A baking device for baking transparent substrate coated with metallic paste layer, the baking device comprising:
a supporter having an inlet and an outlet;
a near-infrared light source arranged on one side of the supporter and providing infrared light with a predetermined wavelength;
a baking area arranged on one side of the supporter and corresponding to the near-infrared light source, the baking area having a predetermined distance with the near-infrared light source,
wherein thin transparent substrates are fixed in roll-by-roll or in batch to the baking area of the baking device, and the near-infrared light source irradiates infrared light with the predetermined wavelength to the thin transparent substrates.

21. The baking device in claim 20, wherein the supporter comprises a plurality of plates and pillars, and is made of stainless steel.

22. The baking device in claim 20, wherein the near-infrared light source comprises a plurality of near-infrared generators to generate a near-infrared light with wavelength of 800-2000 nm, peak wavelength of 1000 nm and power of 2.78˜8.46 W.

23. The baking device in claim 22, wherein the near-infrared light source has power more than 4 W.

24. The baking device in claim 20, wherein the baking area has a baking stage made of stainless steel and corresponding to the near-infrared light source, the baking stage is separated with the near-infrared light source by 15-50 cm.

25. The baking device in claim 24, wherein the baking stage is corresponding to the near-infrared light source, the baking stage is separated with the near-infrared light source by 25˜30 cm.

26. The baking device in claim 24, wherein the baking stage is covered with a non-heat accumulating unit made of teflon glass fabrics.

27. The baking device in claim 24, wherein the baking stage has a lifting positioning unit, the lifting positioning unit has a baffle driven by a level-lifter in the baking stage, the level-lifter is pneumatic cylinder or hydraulic cylinder.

28. The baking device in claim 22, wherein a static baking operation is conducted under the conditions of 25/100˜30/150 cm/second, where length unit cm is used to count a vertical distance between the near-infrared light source and the thin transparent substrate, and time unit second is used to count the baking time.

29. The baking device in claim 20, wherein the baking area is a roller set to provide dynamic baking, the roller is made of stainless steel and has conveying belt made of teflon glass fabrics.

30. The baking device in claim 22, wherein a dynamic baking operation is conducted under the conditions of 25/70˜30/100 cm/second, where length unit cm is used to count a vertical distance between the near-infrared light source and the thin transparent substrate, and time unit second is used to count the baking time.

31. The baking device in claim 20, further comprising a feeder mechanism and a discharging mechanism arranged at front end and rear end of the baking device, respectively, a rear end of the feeder mechanism is coupled to a cooling stabilization region.

32. The baking device in claim 20, further comprising an air exhauster arranged on one side of the supporter.

33. The baking device in claim 20, further comprising a supporting tray, the supporting tray is made of plastic substrate or glass substrate.
